(19) United States
(12) Patent Application Publication
(10) Pub. No.: US 2007/0260926 A1
(43) Pub. Date: Nov. 8, 2007

(54) STATIC AND DYNAMIC LEARNING TEST GENERATION METHOD

(75) Inventors: Donato O. Forlenza, Hopewell Junction, NY (US); Orazio P. Forlenza, Hopewell Junction, NY (US); Mary P. Kusko, Hopewell Junction, NY (US)

Correspondence Address: CANTOR COLBURN LLP - IBM ROCHESTER DIVISION, 55 GRIFFIN ROAD SOUTH, BLOOMFIELD, CT, 06002, US

(73) Assignee: International Business Machines Corporation, Armonk, NY (US)

(21) Appl. No.: 11/279,609

(22) Filed: Apr. 13, 2006

(51) Int. Cl. G06F 11/00

(52) U.S. Cl. 714/33

(57) ABSTRACT

Exemplary embodiments include a static and dynamic test generation and simulation method including: analyzing a logic model; identifying a logic structure in the logic model whose input/output signal can be assigned to a particular logical value and remain fixed during a fault simulation test; and running the fault simulation test to check the logic model for faults.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This invention relates generally to the testing of logical structures methods and particularly to static and dynamic fault simulation and test generation method.

2. Description of Background

With the increasing density and size of Very-Large-Scale Integration (VLSI) structures it is becoming necessary to further reduce test generation and fault simulation times. This increase in test generation and fault simulation efficiency must be realized while still achieving the same quality DC/AC test overages obtained via current methods. These long simulation times during LSSD (level sensitive scan design) Deterministic, Weighted Random Pattern (WRP), and various forms of BIST test generation considerably add to total test cost and in some cases are extremely prohibitive for particular test modes and test pattern types. Costly Deterministic, WRP, and BIST (built in self test) test generation and fault simulation times and resources are becoming more of a constraint on the system, and will be unacceptable for future products with today's aggressive system cycle times.

Current test structures, methodologies, and Automated Test Pattern Generation (ATPG) software do not take advantage of structural regularity, resulting in larger test data volumes and longer test times. Essentially, the logic in a VLSI design is treated as flat, random logic. A typical example of a regular structure consists of Register Arrays (RA). As the name suggests, they are highly regular structures having the array and read multiplexing treated as independent but identical bit-slices. Since VLSIs design typically have a large number of register arrays, often with more storage elements in the arrays than that found in conventional (random) logic, and since such arrays are inherently more difficult to test due to the addressing requirements, the problem of testing such VLSIs designs have become unmanageable. In addition to storage arrays, it has become increasingly common to find functional blocks in the chip replicated several times. As a result, many chips have significant portions of their logic organized as repeated structures. Current ATPG techniques are unable to take advantage of this repetition, leading to an excessive test data volume and test application times.

Current ATPG programs are unable to take into consideration multiple, repeated, structures because of the inherent assumption built into all ATPG programs, and all Design For Test rules, that data in different memory elements of the scan chains should be independent of all each other. That is, the data should be uncorrelated. When testing random logic, i.e., wherein an arbitrary subset of the storage elements in the scan chains feed an arbitrary Boolean expression, this independence is required to avoid non-testable faults. Indeed, within a single repeated structure, this requirement for independence of the stimulus data still holds. However, when a structure is repeated multiple times, and each copy of the structure is independent of other copies, then, identical (fully correlated) stimulus data may be scanned into each copy of the structure without creating non-testable faults.

Different methods and techniques of performing test generation and fault simulation have historically been utilized to reduce simulation times, ranging from Parallel Pattern Single Fault Propagate (PPSFP) and fan-out free network approaches to LSSD Deterministic and BIST test generation methods.

### SUMMARY

The shortcomings of the prior art are overcome and additional advantages are provided through the provision of test generation methods.

Exemplary embodiments include a static test generation and simulation method including: analyzing a logic model; identifying a logic structure in the logic model whose input/output signal can be assigned to a particular logical value and remain fixed during a fault simulation test; and running the fault simulation test to check the logic model for faults.

Exemplary embodiments also include a dynamic test generation and simulation method including: analyzing a logic model; running a fault simulation test to check the logic model for faults; and identifying a logic structure in the logic model whose input/output signal can be assigned to a particular logical value and remain fixed during a fault simulation test, wherein identifying a logic structure is performed during the running of the fault simulation test.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that allows quick and efficient fault simulation and test generation for logical models.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow chart of a static and dynamic learning test generation method in accordance with exemplary embodiments;

FIG. 2 illustrates an exemplary logic model for use with the static and dynamic learning test method;

FIG. 3 illustrates another exemplary logic model for use with the static and dynamic learning test method; and

FIG. 4 illustrates another exemplary logic model for use with the static and dynamic learning test method.

The detailed description explains the preferred embodiments of the invention, together with advantages and features, by way of example with reference to the drawings.

### DETAILED DESCRIPTION

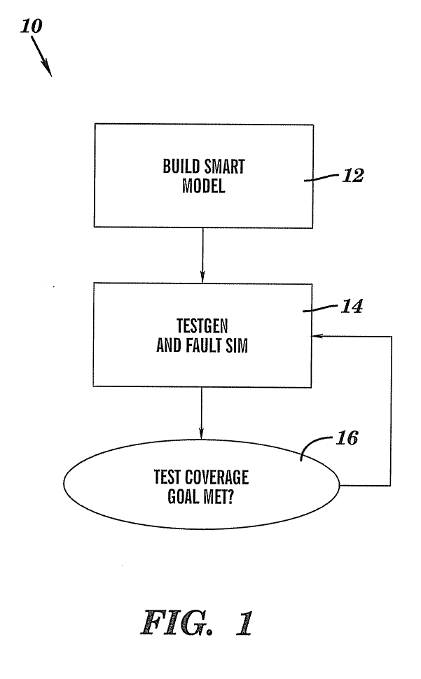

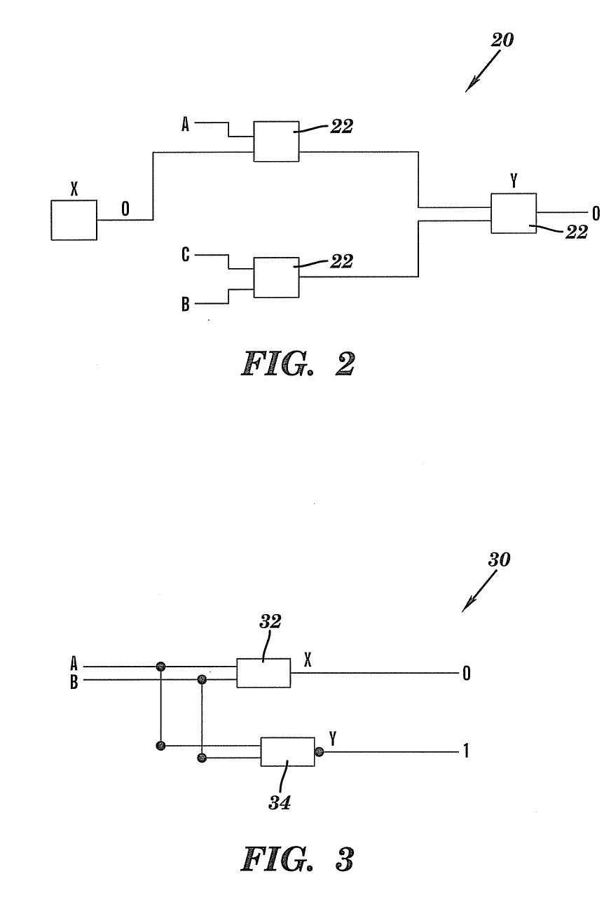

Referring now to FIG. 1, a flow chart of an exemplary embodiment of a static and dynamic learning test generation method is generally depicted as 10. The first step in the method 10 is to build a smart logic model, as shown at method step 12. Exemplary embodiments of the logic model are discussed herein in further detail with reference to FIGS. 2, 3, and 4. The next step in the method 10 is to perform test generation and faulty simulation tests against the smart model, as shown at method step 14. Performing test generation and faulty simulation tests against the smart model may include identifying a logic structure in the logic model whose input/output signal can be assigned to a particular logical value and remain fixed during a particular fault simulation test. After identifying the logic structure, the method 10 includes determining if test goal coverage has been met, as shown at method step 16. If the test goal coverage has been met the method 10 concludes, otherwise the method returns to method step 12. The method 10 improves the fault simulation tests of these logic structures by reducing the logic structure to a small subset of logic blocks.

In an exemplary embodiment, the test generator needs to trace back sufficient paths to set up the activation and propagation values to detect a fault. Trace backs on these logic structures are performed using the same analysis of logic structures as shown at method steps 12 and 14, which reduces the time required for test generation. For example, the test generator might need a certain value but because of the analysis, the test generator will already know either that the value is achieved or not achievable through a particular path. In addition, there could be many instances of this logic structure across the logic model and thereby provide even more reduction in test generation or fault simulation time. By performing the method 10, the number of forward and backward implications made during test generation or fault simulation, especially upon large logic structures, can be greatly simplified. The simplification of the logic structure will cause a reduction in the overall simulation time.

The implementation of the method 10 can take on various forms. In one exemplary embodiment, implementation of the method 10 is strictly based upon logic model tracing that would identify these logic structures and multiple instances of them within the logic model. These logic model tracing algorithms are of the same form and nature that can also be used to identify certain logic topological configurations and functions such as clock choppers, fan-out free networks, re-convergent fan-out, redundant faults, L1 latch to L1 latch paths, L2 latch to L2 latch paths, L2 latch to L3 latch paths, L3 latch to L1/L2 latch paths, ‘A’/‘B’/‘P’ clock to PO paths, L1/L2/L3 latch to PO paths, PI to PO paths, and the like. There are many efficient logic model-tracing algorithms that can be employed to identify these structures including, but not limited to, the “ping-pong” and the “shotgun” tracing methods. For example, the ping-pong method traverses the logic blocks one path at a time, whereas the shotgun method traces the logic blocks one level of logic at a time. Regardless of the algorithm that is used, as the logic model is traversed the configuration of the logic is duly noted in the form of special data structures in the logic model trace software to identify each logic block making up these special structures. These data structures or “flags” are then made available to the test generation/fault simulation software.

Some simple examples of these logic structures applicable to the static learning method are described below with reference to FIGS. 2, 3, and 4 and can be performed for more intelligent forward and backward implications during test generation and fault simulation. The actual simulation timesavings are design-dependent, depending upon the number of structures within a design that can be “learned” statically and/or dynamically.

Referring now to FIG. 2, a simple logical model is depicted generally as 20. The logic model 20 includes an input signals X, A, B, and C, an output signal Y, and three AND gates 22. As depicted in the logic model 20, if the input signal X is 0 then the output signal Y will also be 0 regardless of values of the input signals of A, B, or C. The simulation benefit that can be derived from this analysis of the logic model 20 is that if X is 0 then Y will be 0 therefore no need to simulate A, B, or C. The test generation benefit that can be derived from this analysis of the logic model 20 is that if the test doesn't require Y to be 0 then there is no need to trace back the values of A, B, or C and there is similarly no need to set X to 0.

Referring now to FIG. 3, another simple logic model is depicted generally as 30. The logic model 30 includes input signals A and B, output signals X and Y, a AND gate 32, and a NAND gate 34. As depicted in the logic model 30, it is not possible for the output signals X and Y to have the same value. The simulation benefit that can be derived from this analysis of the logic model 30 is that if output signal X is n then the output signal Y is the opposite value of n and there is no need to simulate Y. The test generation benefit that can be derived from this analysis of the logic model 30 is that if output signals X and Y need to be the same value the condition cannot be satisfied and there is no need to run a test generation.

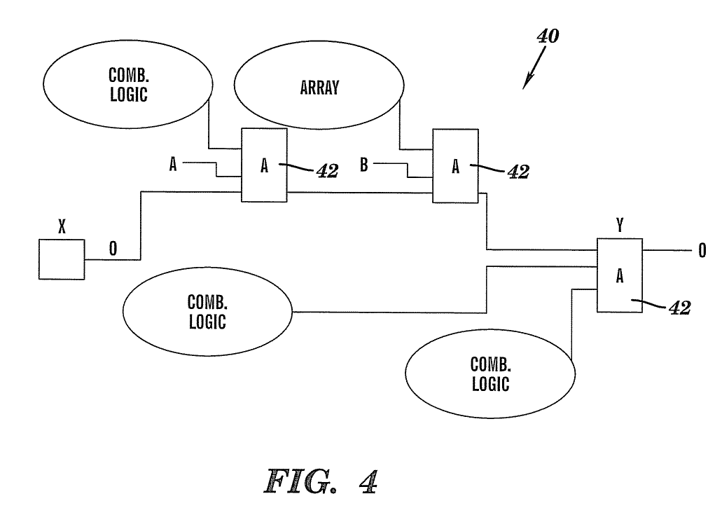

Referring now to FIG. 4, another simple logic model is depicted generally as 40. The logic model 40 includes input signals A and B, output signals X and Y, and AND gates 42. As depicted in the logic model 40, if the input signal X is 0 then the output signal Y will also be 0 regardless of values of the input signals of A, B, C, or any of the other sources of combinational logic. The simulation benefit that can be derived from this analysis of the logic model 40 is that if X is 0 then Y will be 0 therefore no need to simulate A, B, C, or any of the other sources of combinational logic. The test generation benefit that can be derived from this analysis of the logic model 40 is that if the test doesn't require Y to be 0 then there is no need to trace back the values of A, B, or C and there is similarly no need to set X to 0.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A static test generation and simulation method comprising:
analyzing a logic model;
identifying a logic structure in the logic model whose input/output signal can be assigned to a particular logical value and remain fixed during a fault simulation test; and
running the fault simulation test to check the logic model for faults.

2. The static test generation and simulation method of claim 1, wherein identifying the logic structure in the logic model whose input/output signal can be assigned to a particular logical value and remain fixed during a fault simulation test provides a reduction in test generation or fault simulation time.

3. The static test generation and simulation method of claim 2, wherein running the fault simulation test to check the logic model for faults includes tracing back sufficient paths to set up activation and propagation values.

4. The static test generation and simulation method of claim 3, further comprising identifying multiple instances of the logic structure in the logic model.

5. The static test generation and simulation method of claim 4, wherein the identification of multiple instance of the logic structure across the logic model provides a further reduction in test generation or fault simulation time.

6. A dynamic test generation and simulation method comprising:
analyzing a logic model;
running a fault simulation test to check the logic model for faults; and
identifying a logic structure in the logic model whose input/output signal can be assigned to a particular logical value and remain fixed during a fault simulation test, wherein the identifying a logic structure is performed during the running of the fault simulation test.

7. The dynamic test generation and simulation method of claim 6, wherein identifying the logic structure in the logic model whose input/output signal can be assigned to a particular logical value and remain fixed during a fault simulation test provides a reduction in test generation or fault simulation time.

8. The dynamic test generation and simulation method of claim 7, wherein running the fault simulation test to check the logic model for faults includes tracing back sufficient paths to set up activation and propagation values.

9. The dynamic test generation and simulation method of claim 8, further comprising identifying multiple instances of the logic structure in the logic model.

10. The dynamic test generation and simulation method of claim 9, wherein the identification of multiple instance of the logic structure across the logic model provides a further reduction in test generation or fault simulation time.

11. A test generation and simulation method comprising:
a static operation mode including:
analyzing a logic model;
identifying a logic structure in the logic model whose input/output signal can be assigned to a particular logical value and remain fixed during a fault simulation test; and
running the fault simulation test to check the logic model for faults;
identifying multiple instances of the logic structure in the logic model;
wherein identifying the logic structure in the logic model whose input/output signal can be assigned to a particular logical value and remain fixed during a fault simulation test provides a reduction in test generation or fault simulation time;
wherein running the fault simulation test to check the logic model for faults includes tracing back sufficient paths to set up activation and propagation values.
wherein the identification of multiple instance of the logic structure across the logic model provides a further reduction in test generation or fault simulation time;
a dynamic operation mode including:
analyzing a logic model;
running a fault simulation test to check the logic model for faults;
identifying a logic structure in the logic model whose input/output signal can be assigned to a particular logical value and remain fixed during a fault simulation test, wherein the identifying a logic structure is performed during the running of the fault simulation test;
identifying multiple instances of the logic structure in the logic model;
wherein identifying the logic structure in the logic model whose input/output signal can be assigned to a particular logical value and remain fixed during a fault simulation test provides a reduction in test generation or fault simulation time;
wherein running the fault simulation test to check the logic model for faults includes tracing back sufficient paths to set up activation and propagation values;
wherein the identification of multiple instance of the logic structure across the logic model provides a further reduction in test generation or fault simulation time.
